(19) United States
(12) Patent Application Publication
(10) Pub. No.: US 2019/0250736 A1
(43) Pub. Date: Aug. 15, 2019

(54) CAPACITIVE SENSING APPARATUS, EVENT DETECTION METHOD FOR MEASUREMENT ENVIRONMENT OF CAPACITIVE SENSING APPARATUS, AND METHOD FOR DETERMINING CORRECTION TIMING OF CAPACITIVE SENSING APPARATUS

(71) Applicant: Shang-Li LEE, Keelung City (TW)

(72) Inventor: Shang-Li LEE, Keelung City (TW)

(21) Appl. No.: 16/267,616

(22) Filed: Feb. 5, 2019

(30) Foreign Application Priority Data
Feb. 14, 2018 (TW) 107105575

(51) Int. Cl. G06F 3/044; G06F 3/041

(52) U.S. Cl. CPC G06F 3/044; G06F 3/0418

(57) ABSTRACT

A capacitive sensing apparatus, an event detection method for a measurement environment of a capacitive sensing apparatus, and a method for determining a correction timing of a capacitive sensing apparatus are applicable to a capacitive sensing apparatus. The capacitive sensing apparatus uses a signal simulation unit to directly simulate signal strength or a sensing signal of a touch, then determines, based on the simulated signal strength or sensing signal and an actually measured sensing signal, whether a measurement condition is suitable, and performs proper adjustment, thereby improving the accuracy and/or the identification rate of the capacitive sensing apparatus.

### CROSS-REFERENCE TO RELATED APPLICATION

This non-provisional application claims priority under 35 U.S.C. § 119(a) to patent Application No. 107105575 in Taiwan, R.O.C. on Feb. 14, 2018, the entire contents of which are hereby incorporated by reference.

### BACKGROUND

### Technical Field

The present invention relates to capacitive sensing technologies, and in particular, to a capacitive sensing apparatus, an event detection method for a measurement environment of a capacitive sensing apparatus, and a method for determining a correction timing of a capacitive sensing apparatus.

### Related Art

To improve the convenience of use, an increasing number of electronic apparatuses use touch screens as operation interfaces. In this way, users can directly perform operations by tapping and selecting images on the touch screens, thereby providing more convenient and humanized operation modes. A touch screen mainly consists of a display providing a display function and a sensing apparatus providing a touch function.

Usually, the sensing apparatus learns, by using a self-capacitance sensing technology and/or a mutual capacitance sensing technology, whether a panel is touched by a user. In a sensing process, when the sensing apparatus detects a change in a capacitance value at a coordinate position, the sensing apparatus determines that the coordinate position is touched by the user. Therefore, during operation, the sensing apparatus stores a capacitance value indicating no touch for each coordinate position, and when a latest capacitance value is received subsequently, determines, by comparing the latest capacitance value with the capacitance value indicating no touch, whether a position corresponding to the capacitance value has been touched.

A measurement condition of the sensing apparatus is an important factor of determining a sensing value. A measurement environment affects a measurement result, including the accuracy, the identification rate, and the like. The sensing apparatus cannot predict the measurement environment. Therefore, a manual correction process needs to be introduced to ensure the measurement consistency.

### SUMMARY

In view of the foregoing problem, a detection mechanism is required to learn about impact of a to-be-measured environment on a measurement value of a capacitive sensing apparatus, and to determine a signal parameter used for measurement to obtain an accurate measurement value.

In an embodiment, an event detection method for a measurement environment of a capacitive sensing apparatus includes: sequentially selecting one set from a plurality of sets of signal parameters; performing event detection of a measurement environment in accordance with the selected set of signal parameters; and establishing a standard reference set corresponding to each set of the plurality of sets of signal parameters in a storage unit. The step of performing event detection of a measurement environment in accordance with the selected set of signal parameters includes: performing touch detection in accordance with the selected set of signal parameters by a signal sensor, to generate a background sensing signal; generating a touch simulation signal by using a signal simulation unit; and obtaining a standard reference set corresponding to the selected set of signal parameters according to the background sensing signal and the touch simulation signal.

In an embodiment, a method for determining a correction timing of a capacitive sensing apparatus includes: performing touch detection in accordance with a set of signal parameters by a signal sensor, to generate a background sensing signal; generating a touch simulation signal by using a signal simulation unit; and obtaining a measurement signal set according to the background sensing signal and the touch simulation signal; calculating a variation amount based on a standard reference set and the measurement signal set; adjusting the set of signal parameters when the variation amount exceeds a threshold; and skipping adjusting the set of signal parameters when the variation amount does not exceed the threshold.

In an embodiment, a capacitive sensing apparatus includes a signal sensor and a signal processing circuit. The signal sensor includes a plurality of first electrodes and a plurality of second electrodes crossing the first electrodes. The signal processing circuit is electrically connected to the signal sensor, and the signal processing circuit performs: driving the signal sensor to perform touch detection in accordance with a set of signal parameters, to generate a background sensing signal; generating a touch simulation signal for a simulated touch event; obtaining a measurement signal set by integrating the background sensing signal with the touch simulation signal; calculating a variation amount based on a standard reference set and the measurement signal set; adjusting the set of signal parameters when the variation amount exceeds a threshold; and skipping adjusting the set of signal parameters when the variation amount does not exceed the threshold.

In conclusion, the capacitive sensing apparatus, the event detection method for a measurement environment of a capacitive sensing apparatus, and the method for determining a correction timing of a capacitive sensing apparatus according to the present invention are applicable to a capacitive sensing apparatus. The capacitive sensing apparatus uses a signal simulation unit (software or hardware) to directly simulate signal strength of an event, then determines, based on the simulated signal strength and an actually measured sensing signal, whether a signal parameter is suitable, and performs corresponding adjustment in due time, thereby improving the accuracy and/or the identification rate of the capacitive sensing apparatus.

### BRIEF DESCRIPTION OF THE DRAWINGS

The present invention will become more fully understood from the detailed description given herein below for illustration only, and thus are not limitative of the present invention, and wherein:

FIG. 1 is a schematic block diagram of a capacitive sensing apparatus according to an embodiment of the present invention;

FIG. 2 is a schematic diagram of an embodiment of a signal sensor in FIG. 1;

FIG. 3 is a schematic flowchart of an event detection method for a measurement environment of a capacitive sensing apparatus according to an embodiment of the present invention;

FIG. 4 is a schematic flowchart of a method for determining a correction timing of a capacitive sensing apparatus according to an embodiment of the present invention;

FIG. 5 is a schematic diagram of an embodiment of a signal simulation unit in FIG. 1;

FIG. 6 is a schematic diagram of another embodiment of a signal simulation unit in FIG. 1;

FIG. 7 is a schematic diagram of still another embodiment of a signal simulation unit in FIG. 1; and

FIG. 8 is a schematic flowchart of an embodiment of step S11 in FIG. 4.

### DETAILED DESCRIPTION

First, a method for determining a correction timing of a capacitive sensing apparatus according to any embodiment of the present invention can be applicable to a capacitive sensing apparatus, for example, but not limited to, a touch panel, an electronic drawing board, or a handwriting board. In some embodiments, the capacitive sensing apparatus and a display may further be integrated into a touch screen. In addition, a touch on the capacitive sensing apparatus may be performed by a hand or a touch element such as a stylus or a touch brush.

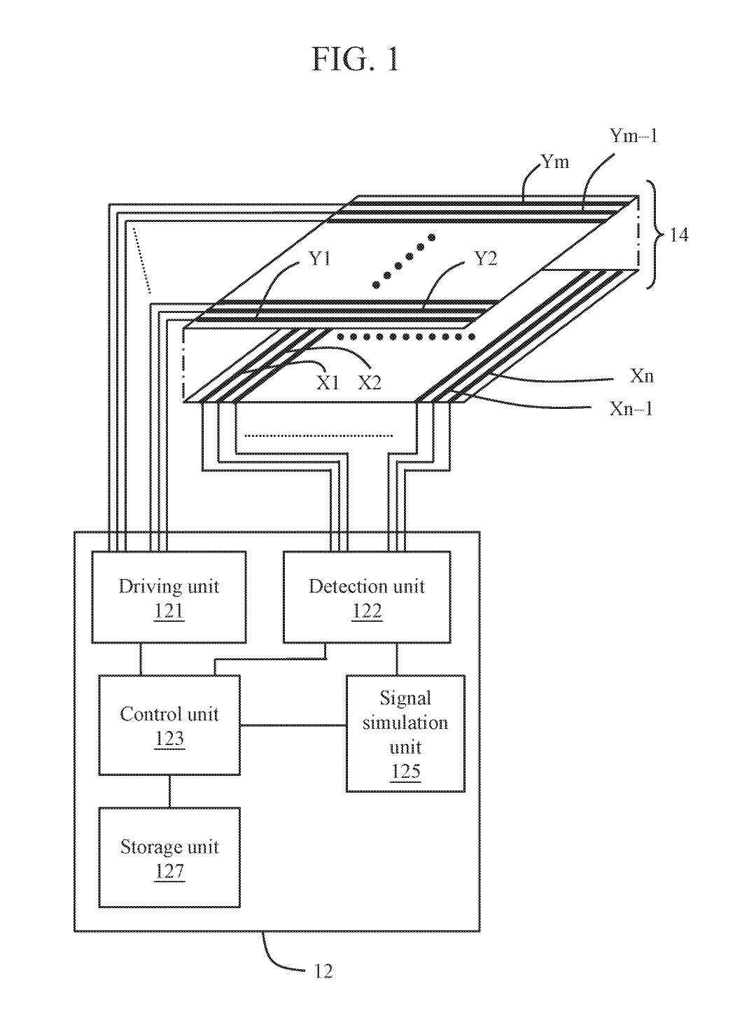

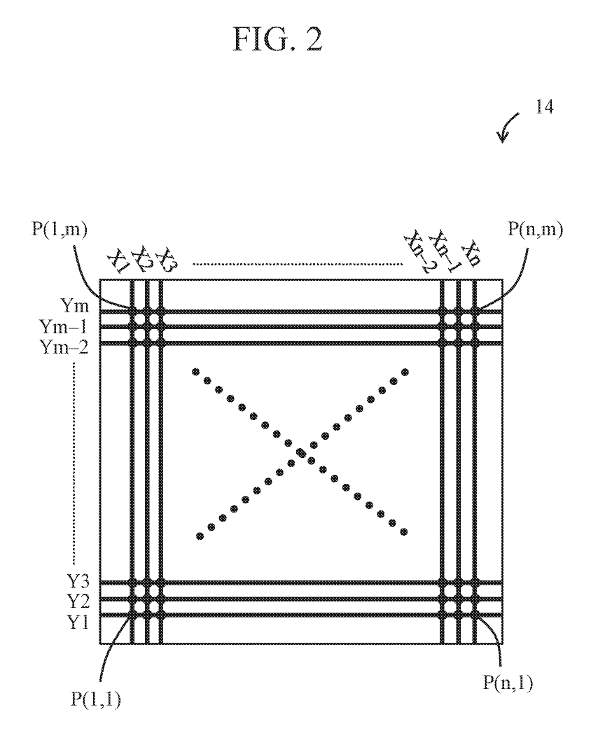

FIG. 1 is a schematic block diagram of a capacitive sensing apparatus according to an embodiment of the present invention. FIG. 2 is a schematic diagram of an embodiment of a signal sensor in FIG. 1. Referring to FIG. 1 and FIG. 2, the capacitive sensing apparatus includes a signal processing circuit 12 and a signal sensor 14. The signal sensor 14 is connected to the signal processing circuit 12.

The signal sensor 14 includes a plurality of electrodes (for example, first electrodes X1 to Xn and second electrodes Y1 to Ym), and the first electrodes X1 to Xn crosses the second electrodes Y1 to Ym, where n and m are positive integers, and n may be equal to m or may be not equal to m. From a top view, the first electrodes X1 to Xn and the second electrodes Y1 to Ym are staggered with each other, and define a plurality of sensing points P(1,1) to P(n,m) configured in a matrix. The signal processing circuit 12 includes a driving/detection unit and a control unit 123. The control unit 123 is coupled to the driving/detection unit. The driving/detection unit includes a driving unit 121 and a detection unit 122. Herein, the driving unit 121 and the detection unit 122 may be integrated into a single element, or may be implemented by two elements. This is determined according to an actual situation in an end view design. The driving unit 121 is configured to output a driving signal to an electrode. The detection unit 122 is configured to measure a capacitance value of an electrode. Herein, the control unit 123 may be configured to: control operation of the driving unit 121 and the detection unit 122, and determine a change in a capacitance value at each sensing point according to a background value (a capacitance value indicating no touch) and a measurement value.

The signal processing circuit 12 may use a self-capacitance detection technology or a mutual capacitance detection technology to perform touch detection. In an example of the self-capacitance detection technology, during touch detection, after the driving unit 121 drives an electrode, the detection unit 122 can detect a self-capacitance value of the electrode, thereby detecting a change in the capacitance value (relative to a corresponding background value). Herein, in the detection of the self-capacitance value, the change in the capacitance value may be estimated by measuring a time spent in charging the electrode to a voltage level (for example, a TCSV (Time to Charge to Set Voltage) method) or be estimated with a voltage value obtained after charging is performed for a particular time (for example, a VACST (Voltage After charging for a Set Time) method). In an example of the mutual capacitance detection technology, during touch detection, the driving unit 121 selects a first electrode and a second electrode to perform driving, and then the detection unit 122 measures a mutual capacitance value between the selected first electrode and the selected second electrode, thereby detecting a change in the capacitance value. Herein, after it is measured that the capacitance value changes to some extent, the control unit 123 may determine that a corresponding sensing point is touched, and determine, based on a determining result, whether to return a corresponding position signal.

Herein, the capacitive sensing apparatus can proactively perform the method for determining a correction timing of a capacitive sensing apparatus according to any embodiment of the present invention, so that a measurement result of the capacitive sensing apparatus is adapted to the measurement environment, thereby avoiding problems such as a reduction in the accuracy and the identification rate and misjudgment that are caused by a change in the measurement environment.

Still referring to FIG. 1, the signal processing circuit 12 may further include a signal simulation unit 125 and a storage unit 127. The control unit 123 is coupled to the storage unit 127. The signal simulation unit 125 is electrically connected to the detection unit 122 and is controlled by the control unit 123. In an embodiment, operation of the signal simulation unit 125 can be implemented by disposing gauging software/hardware facilities in the signal processing circuit 12.

Under the control of the control unit 123, the capacitive sensing apparatus selectively performs a normal process and a correction process.

In the normal process, the detection unit 122 is disconnected from (there is no signal connected to) the signal simulation unit 125, so that the control unit 123 directly performs signal processing on the measurement value of the detection unit 122, to determine the change in the capacitance value at each sensing point. In the correction process, the detection unit 122 is conductively connected to the signal simulation unit 125. A signal of the signal simulation unit 125 is coupled to an input of the detection unit 122. Herein, the signal simulation unit 125 is configured to: generate a touch simulation signal required for determining whether correction is to be performed, and integrate the touch simulation signal with the capacitance value obtained by the detection unit 122 through the signal sensor 14.

The storage unit 127 stores a threshold required for correction and a standard reference set corresponding to each of a plurality of sets of signal parameters. In other words, each set of signal parameters represent a driving manner obtained by combining various frequencies, gains, waveforms, voltages, and the like. Herein, the threshold and the standard reference set can be determined through repeated tests in a clean environment (for example, a test room before delivery) and be prestored in the storage unit 127.

Each standard reference set corresponds to one set of signal parameters, and each standard reference set includes an allowable (acceptable) range of a touch sensing signal and an allowable (acceptable) range of a background sensing signal (base signal).

In some embodiments, the standard reference set is generated through repeated tests in a clean environment (for example, a test room before delivery) and according to records respectively obtained with a touch simulation signal and no touch simulation signal. In other words, the capacitive sensing apparatus can perform event detection on a measurement environment in a clean environment (that is, an event in the measurement environment is controlled), so as to establish the standard reference set corresponding to each set of the plurality of sets of signal parameters. A value of at least one signal parameter of any set of signal parameters among the sets of signal parameters is different from that of a signal parameter of another set of signal parameters. “Event” mentioned in this specification refers to impact of environmental factors such as a touch, pressure, and a temperature on a measurement value of each detection point, and is presented as a change in the measurement value.

In an embodiment, the standard reference set is generated in a factory environment with a background sensing signal in combination with the touch simulation signal generated by the signal simulation unit 125, where the background sensing signal is generated by the signal sensor 14 by performing touch detection in accordance with a corresponding set of signal parameters when there is no touch element.

In another embodiment, the standard reference set is generated in a factory environment by performing touch detection in accordance with a corresponding set of signal parameters in combination with a background sensing signal when there is a touch element on the signal sensor 14, where the background sensing signal is generated by the signal sensor 14 by performing touch detection in accordance with a corresponding set of signal parameters when there is no touch element on the signal sensor 14.

A process of establishing the standard reference set in the capacitive sensing apparatus is further described in detail below.

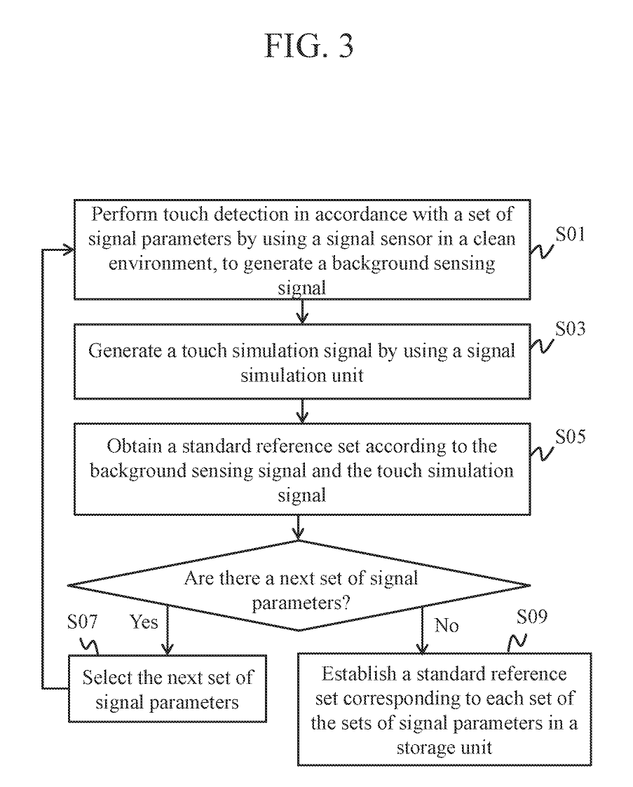

Referring to both FIG. 1 and FIG. 3, in some embodiments, the capacitive sensing apparatus performs touch detection in accordance with a set of signal parameters in a clean environment by using the signal sensor 14, to generate a background sensing signal (step S01). Herein, under the driving control of the control unit 123, the driving unit 121 generates a driving signal having a set of signal parameters and sends the driving signal to the signal sensor 14. The detection unit 122 measures a capacitance value indicating no touch for the signal sensor 14, thereby receiving a background sensing signal generated by the signal sensor 14. In other words, when the capacitance value indicating no touch is measured, there is no touch element (for example, a hand, a stylus, or a touch brush) on the signal sensor 14.

The signal simulation unit 125 generates a touch simulation signal for a simulated touch event (step S03). The control unit 123 obtains a standard reference set based on the background sensing signal and the touch simulation signal (step S05). In step S05, the signal simulation unit 125 can superimpose the touch simulation signal on the background sensing signal, to form a touch sensing signal generated at a touch point by a touch element. In some embodiments, the control unit 123 can define an allowable (acceptable) range of the background sensing signal by performing statistical operation on background measurement values (which form the background sensing signal) at all sensing points P(1,1) to P(n,m), and define an allowable (acceptable) range of the touch sensing signal by performing statistical operation on touch measurement values (which form the touch sensing signal) at all the sensing points P(1,1) to P(n,m), thereby obtaining the standard reference set for the set of signal parameters. In some other embodiments, for a same set of signal parameters, step S01 can be repeated for several times, to obtain a plurality of background sensing signals as well as a plurality of touch sensing signals obtained after a touch simulation signal is superimposed on the background sensing signals separately. The control unit 123 can define the allowable (acceptable) range of the background sensing signal by performing statistical operation on the plurality of background sensing signals, and define the allowable (acceptable) range of the touch sensing signal by performing statistical operation on the plurality of touch sensing signals, thereby accordingly obtaining the standard reference set for the set of signal parameters.

Then, the control unit 123 further selects a next set of signal parameters (step S07), and performs step S01 to step S05 again to obtain a standard reference set corresponding to the new set of signal parameters. By analog, until standard reference sets corresponding to all the sets of signal parameters are obtained. The control unit 123 establishes event reference information in accordance with the standard reference sets corresponding to all the sets of signal parameters in the storage unit 127 (step S09), that is, stores the standard reference sets corresponding to all the sets of signal parameters.

The correction process of the capacitive sensing apparatus is further described in detail blow.

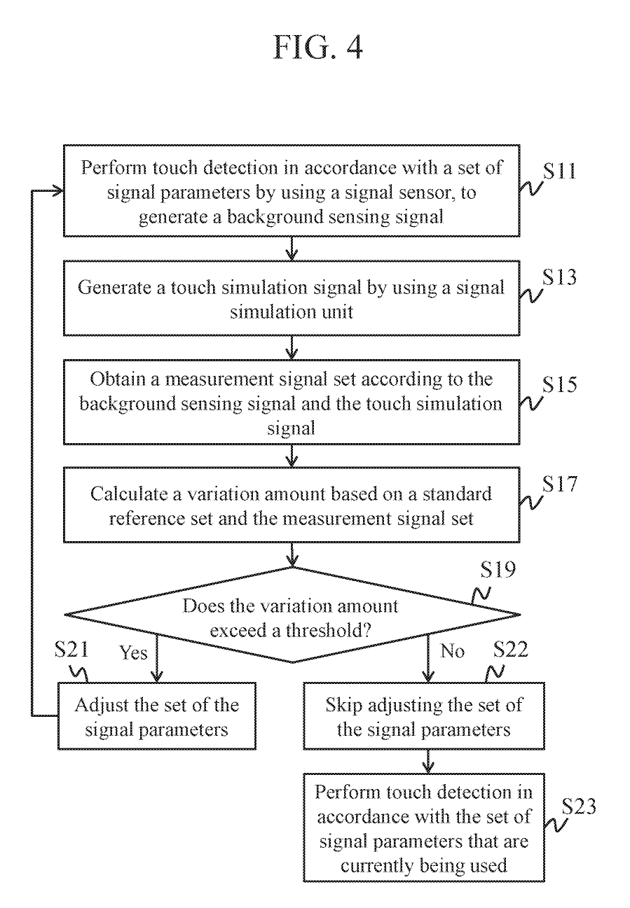

FIG. 4 is a schematic flowchart of a method for determining a correction timing of a capacitive sensing apparatus according to an embodiment of the present invention.

Referring to all of FIG. 1, FIG. 2, and FIG. 4, the capacitive sensing apparatus performs touch detection in accordance with a set of signal parameters by using the signal sensor 14, to generate a background sensing signal (step S11). Herein, under the driving control of the control unit 123, the driving unit 121 generates a driving signal having a set of signal parameters and sends the driving signal to the signal sensor 14. The detection unit 122 measures a capacitance value indicating no touch for the signal sensor 14, thereby receiving a background sensing signal generated by the signal sensor 14. In other words, when the capacitance value indicating no touch is measured, there is no touch element (for example, a hand, a stylus, or a touch brush) on the signal sensor 14.

The signal simulation unit 125 generates a touch simulation signal for a simulated touch event (step S13). The control unit 123 obtains a measurement signal set based on the background sensing signal and the touch simulation signal (step S15), and performs signal comparison. The measurement signal set includes a signal generated when there is a touch point and a signal generated when there is no touch point. In this embodiment, the touch simulation signal is equivalent to occurrence of a touch event. For example, the touch simulation signal is simulating signal strength of a finger signal. The signal simulation unit 125 superimposes the finger signal (the touch simulation signal) on the background sensing signal, to form a touch sensing signal generated at a touch point by a touch element. In addition, the background sensing signal (a signal generated when there is no touch point) and the touch sensing signal (a signal generated when there is a touch point) form the measurement signal set. In addition, in another example, the touch simulation signal may also be simulating signal strength of a conductive foreign material (for example, water).

The control unit 123 calculates a variation amount (referred to as a current variation amount hereinafter) based on the standard reference set and the measurement signal set (step S17), and determines whether the variation amount exceeds a threshold (step S19). In some embodiments, the standard reference set may be a digital signal, that is, a signal obtained after an analog measurement signal including a capacitance, a voltage, and a current is converted through an analog-to-digital converter. In this case, the control unit 123 may first convert the received analog measurement signal into a digital measurement signal, and then compare the digital measurement signal with a corresponding standard signal in the standard reference set.

When the variation amount exceeds the threshold, the control unit 123 adjusts the set of signal parameters used by the capacitive sensing apparatus (step S21). After step S21, step S11 is returned to be performed again in accordance with the adjusted signal parameters, and subsequent steps are continued to be performed, until the variation amount does not exceed the threshold. When the variation amount does not exceed the threshold, the control unit 123 does not adjust the signal parameters (step S22). That is, correction is completed. In an embodiment, the threshold may be an allowable range formed by an upper limit and a lower limit. In this case, if the variation amount falls between the upper limit and the lower limit, it indicates that the variation amount does not exceed the threshold. Otherwise, if the variation amount does not fall between the upper limit and the lower limit, it indicates that the variation amount exceeds the threshold. In another embodiment, the threshold may be a predetermined value. In this case, if the variation amount is less than or equal to the predetermined value, it indicates that the variation amount does not exceed the threshold. Otherwise, if the variation amount is greater than the predetermined value, it indicates that the variation amount exceeds the threshold.

In some embodiments, the control unit 123 may sequentially selects different sets of signals to perform determining, until a variation amount obtained in accordance with a selected set of signal parameters does not exceed the threshold.

In a subsequent normal process, the signal sensor 14 performs touch detection in accordance with the set of signal parameters that are currently being used (namely, the signal parameters obtained after the correction process is completed) (step S23).

In some embodiments, the signal simulation unit 125 may be implemented by a circuit or software.

In an example, the signal simulation unit 125 may be an impedance switch circuit simulating the signal sensor 14, and may simulate, by conducting or turning off (across) a series resistor in the impedance switch circuit, that a touch occurs or no touch occurs.

For example, a sensing point P(j,i) defined by a driving electrode Xj and a sensing electrode Yi is used as an example. Referring to FIG. 5, the signal simulation unit 125 may include one or more combination circuits, and each combination circuit includes a switch S1 and a resistor R1. Herein, that the driving/detection unit is a capacitance switch circuit is used as an example. The input of the detection unit 122 is coupled to the sensing electrode Yi via the resistor R, and the switch S1 is coupled to both ends of the corresponding resistor R. The driving electrode Xj may be any one of the first electrodes X1 to Xn, that is, j may be any one of 1 to n. The sensing electrode Yi may be any one of the second electrodes Y1 to Ym, that is, i may be any one of 1 to m.

In the normal process, the switch S1 is conductively connected to both ends of the resistor R1. The detection unit 122 directly measures a sensing capacitance of the sensing electrode Yi for the driving electrode Xj, and outputs a measurement value to the control unit 123. In the correction process, the switch S1 is turned off, so that the resistor R1 is electrically connected to the detection unit 122. In this case, a measurement value, measured by the detection unit 122, of a sensing capacitance of the sensing electrode Yi for the driving electrode Xj generates a corresponding pressure drop (a touch simulation signal) via the resistor R1, to form a touch sensing signal, and then the touch sensing signal is output to the control unit 123. In some embodiments, when the signal simulation unit 125 has a plurality of combination circuits, the number of resistors R1 connected to the detection unit 122 depends on on/off of the switches S1 in the combination circuits, to provide touch simulation signal with quite different capacitance values. That is, different resistance values represent signal responses for touches caused by different touch elements (for example, a finger or water). In some embodiments, when the signal simulation unit 125 has single combination circuit with a single switch S1 and a single resistor R1, the resistor R1 may be a variable resistor. The control unit 123 may adjust a resistance value of the variable resistor, so that the resistor R1 provides signal responses for touches caused by different touch elements (for example, a finger, water, or a foreign material).

In another example, the signal simulation unit 125 may be a capacitance switch circuit simulating the signal sensor 14, and may simulate, by conducting or turning off (across) a parallel capacitor in the capacitance switch circuit, that a touch occurs or no touch occurs.

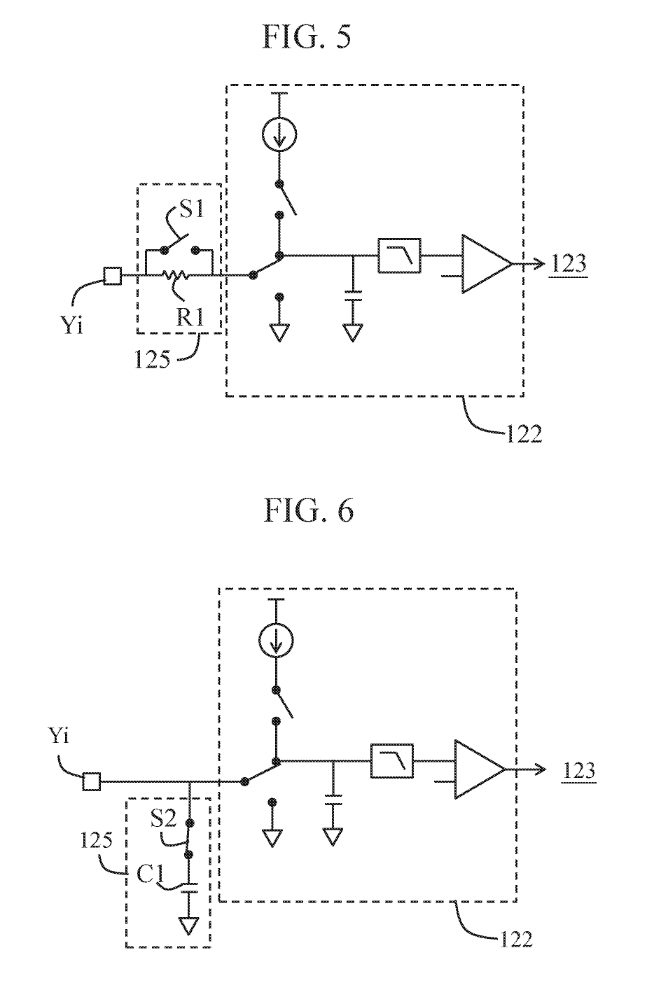

For example, a sensing point P(j,i) defined by a driving electrode Xj and a sensing electrode Yi is used as an example. Referring to FIG. 6, the signal simulation unit 125 may include one or more combination circuits and each combination circuit includes a switch S2 and a capacitor C1. Herein, that the driving/detection unit is a capacitance switch circuit is used as an example. The input of the detection unit 122 is coupled to the sensing electrode Yi, and the capacitor C1 is coupled to the input of the detection unit 122 via the corresponding switch S2. In other words, when the switch S2 is on, a sensing capacitance of the capacitor C1 for the driving electrode Xj is in parallel with that of the sensing electrode Yi for the driving electrode Xj. The driving electrode Xj may be any one of the first electrodes X1 to Xn, that is, j may be any one of 1 to n. The sensing electrode Yi may be any one of the second electrodes Y1 to Ym, that is, i may be any one of 1 to m.

In the normal process, the switch S2 is turned off, and the detection unit 122 directly measures a capacitance value of a sensing capacitance of the sensing electrode Yi, and outputs the capacitance value to the control unit 123. In the correction process, the switch S2 is on, so that a sensing capacitance of the capacitor C1 is in parallel with that of the sensing electrode Yi. After measuring a sum (a touch sensing signal) of a capacitance value of the sensing capacitance of the sensing electrode Yi for the driving electrode Xj and a capacitance value (a touch simulation signal) of the capacitor C1, the detection unit 122 outputs the sum to the control unit 123. In some embodiments, when the signal simulation unit 125 has a plurality of combination circuits, the number of capacitors C1 connected to the detection unit 122 in parallel depends on on/off of the switches S2 in the combination circuits, to provide touch simulation signal with quite different capacitance values. That is, different capacitance values represent touch sensing signals for touches caused by different touch elements (for example, a finger or water). In some embodiments, when the signal simulation unit 125 has a single combination circuit which has a single switch S2 and a single capacitor C1, the capacitor C1 may be a variable capacitor. The control unit 123 may adjust a capacitance value of the variable capacitor, so that the capacitor C1 provides touch signal responses for touches caused by different touch elements (for example, a finger, water, or a foreign material).

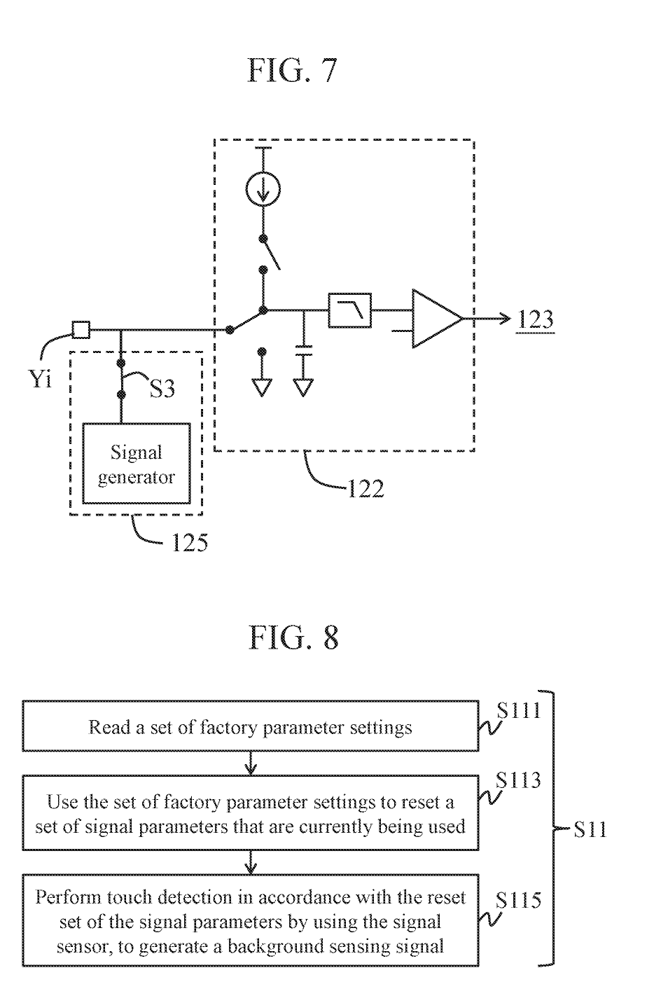

In still another example, referring to FIG. 7, the signal simulation unit 125 may be a signal generator, and the signal generator is coupled to the input of the detection unit 122 via a switch S3. In the normal process, the switch S3 is turned off. In the correction process, the switch S3 is on, and the signal generator may generate a touch simulation signal in a software form. After measuring a sum (a touch sensing signal) of a capacitance value of a sensing capacitance of the sensing electrode Yi for the driving electrode Xj and the touch simulation signal, the detection unit 122 outputs the sum to the control unit 123.

In some embodiments of step S11, referring to FIG. 8, in the correction process, the control unit 123 first reads a set of factory parameter settings from the storage unit 127 (step S111), uses the set of read factory parameter settings to reset a set of signal parameters that are currently being used (step S113), and then performs touch detection by using the signal sensor 14 in accordance with the reset signal parameters, to generate the background sensing signals (step S115).

It should be understood that, an execution order of the steps is not limited to the foregoing order, and may be properly adjusted according to execution content of the steps.

In some embodiments, the set of signal parameters may be a frequency of a driving signal, an amplitude of the driving signal, a waveform of the driving signal, a gain of the driving signal, a voltage of the driving signal, or any combination thereof.

In some embodiments, the signal simulation unit 125 is built in a chip of the capacitive sensing apparatus and is isolated from an external environment of the capacitive sensing apparatus. In other words, with respect to the signal sensor 14, the signal simulation unit 125 is packaged inside, and a finger cannot come into contact with or in close to (to an extent to affect an electrical property of the signal simulation unit 125) the signal simulation unit 125. Therefore, the signal simulation unit 125 is not easily affected by external noise. The chip in which the signal simulation unit 125 is built may be an independent chip that does not implement other elements (the control unit, the driving/detection unit, and a path selection unit), or may be a multifunctional chip that can implement both the signal simulation unit 125 and other elements (the control unit, the driving/detection unit, a path selection unit, or any combination thereof). In other words, the signal processing circuit 12 may be implemented by one or more chips. In some other embodiments, the signal simulation unit 125 may be built on a circuit board of the capacitive sensing apparatus and is isolated from an external environment of the capacitive sensing apparatus.

In some embodiments, the storage unit 127 is configured to store related software/firmware programs, information, data, and a combination thereof. Herein, the storage unit 127 may be implemented by one or more memories.

In conclusion, the capacitive sensing apparatus, the event detection method for a measurement environment of a capacitive sensing apparatus, and the method for determining a correction timing of a capacitive sensing apparatus according to the present invention are applicable to a capacitive sensing apparatus. The capacitive sensing apparatus uses the signal simulation unit 125 (software or hardware) to directly simulate signal strength or a sensing signal of a touch, and then determines, based on the simulated signal strength or sensing signal and an actually measured sensing signal, whether a signal parameter is suitable, and performs proper adjustment, thereby improving the accuracy and/or the identification rate of the capacitive sensing apparatus.

What is claimed is:

1. An event detection method for a measurement environment of a capacitive sensing apparatus, comprising:
sequentially selecting one set from a plurality of sets of signal parameters;
performing event detection of a measurement environment in accordance with the selected set of signal parameters, comprising:
performing touch detection in accordance with the selected set of signal parameters by using a signal sensor, to generate a background sensing signal;
generating a touch simulation signal by using a signal simulation unit; and
obtaining a standard reference set corresponding to the selected set of signal parameters according to the background sensing signal and the touch simulation signal; and
establishing the standard reference set corresponding to each of the plurality of sets of signal parameters in a storage unit.

2. The event detection method for a measurement environment of a capacitive sensing apparatus according to claim 1, wherein the standard reference set comprises an allowable range of the background sensing signal and an allowable range of a touch sensing signal.

3. The event detection method for a measurement environment of a capacitive sensing apparatus according to claim 1, wherein at least one signal parameter of any set of the plurality of sets of signal parameters is different from a signal parameter of another set of signal parameters, and each set of signal parameters comprises a frequency of a driving signal, an amplitude of the driving signal, a waveform of the driving signal, a gain of the driving signal, a voltage of the driving signal, or any combination thereof.

4. A method for determining a correction timing of a capacitive sensing apparatus, comprising:
performing touch detection in accordance with a set of signal parameters by using a signal sensor, to generate a background sensing signal;
generating a touch simulation signal by using a signal simulation unit; and
obtaining a measurement signal set according to the background sensing signal and the touch simulation signal;
calculating a variation amount based on a standard reference set and the measurement signal set;
adjusting the set of signal parameters when the variation amount exceeds a threshold; and
skipping adjusting the set of signal parameters when the variation amount does not exceed the threshold.

5. The method for determining a correction timing of a capacitive sensing apparatus according to claim 4, wherein the step of performing touch detection in accordance with the set of signal parameters by using the signal sensor, to generate a background sensing signal comprises:
reading a set of factory parameter settings;
resetting the set of signal parameters with the set of factory parameter settings; and
performing touch detection in accordance with the set of signal parameters reset by using the signal sensor, to generate the background sensing signal.

6. The method for determining a correction timing of a capacitive sensing apparatus according to claim 4, wherein the measurement signal set comprises the background sensing signal and a touch sensing signal consisting of the background sensing signal and the touch simulation signal.

7. The method for determining a correction timing of a capacitive sensing apparatus according to claim 4, wherein the standard reference set comprises an allowable range of the background sensing signal and an allowable range of a touch sensing signal.

8. The method for determining a correction timing of a capacitive sensing apparatus according to claim 4, wherein the set of signal parameters comprises a frequency of a driving signal, an amplitude of the driving signal, a waveform of the driving signal, a gain of the driving signal, a voltage of the driving signal, or any combination thereof.

9. The method for determining a correction timing of a capacitive sensing apparatus according to claim 4, wherein touch simulation signal is equivalent to occurrence of a touch event.

10. A capacitive sensing apparatus, comprising:
a signal sensor, comprising a plurality of first electrodes and a plurality of second electrodes crossing the first electrodes; and
a signal processing circuit, electrically connected to the signal sensor, and the signal processing circuit performing:
driving the signal sensor to perform touch detection in accordance with a set of signal parameters, to generate a background sensing signal;
generating a touch simulation signal for a simulated touch event;
obtaining a measurement signal set according to the background sensing signal and the touch simulation signal;
calculating a variation amount based on a standard reference set and the measurement signal set;
adjusting the set of signal parameters when the variation amount exceeds a threshold; and
skipping adjusting the set of signal parameters when the variation amount does not exceed the threshold.
